(19) United States
(12) Patent Application Publication
(10) Pub. No.: US 2026/0061673 A1
(43) Pub. Date: Mar. 5, 2026

(54) INJECTION-MOULDED COMPONENT, CONNECTION SYSTEM, STEERING WHEEL COVER PLATE, AND VEHICLE

(71) Applicant: ZF ASIA PACIFIC AUTOMOTIVE SAFETY SYSTEMS (SHANGHAI) CO., LTD, Shanghai (CN)

(72) Inventor: Mao XIN, Shanghai (CN)

(21) Appl. No.: 19/106,685

(22) PCT Filed: Jul. 17, 2023
(86) PCT No.: PCT/CN2023/107755

§ 371 Date: Feb. 26, 2025

(30) Foreign Application Priority Data
Aug. 31, 2022 (CN) 202211055234.7

(51) Int. Cl. B29C 45/00; B29L 31/30

(52) U.S. Cl. CPC B29C 45/0053; B29C 2045/0079; B29K 2995/0005; B29L 2031/3047

(57) ABSTRACT

The present invention relates to an injection-moulded component, a connection system, a steering wheel cover plate, a steering wheel and a vehicle. A surface of the injection-moulded component is provided with a coating that comprises a primer layer applied on the surface of the injection-moulded component, and a metal particle layer is applied on the primer layer by means of physical vapor deposition. It is provided according to the invention that the coating is provided with at least one structural reinforcement portion which is configured to enable the coating to be tolerant to rigid connection implemented by means of the structural reinforcement portion.

### TECHNICAL FIELD

The present invention relates to an injection-moulded component, a connection system, a steering wheel cover plate, a steering wheel and a vehicle. A surface of the injection-moulded component is provided with a coating that comprises a primer layer applied on the surface of the injection-moulded component, and a metal particle layer is applied on the primer layer by means of physical vapor deposition.

### BACKGROUND ART

Physical vapor deposition (PVD) is an industrial manufacturing process, which is a technology mainly using a physical process to deposit a thin film or coating, that is, vacuum coating or evaporation. The physical vapor deposition is usually used for surface treatment of cutting tools and various moulds, as well as in the manufacturing processes of semiconductor devices. Currently, the physical vapor deposition has been widely applied to production of thin films and coatings of various objects, in order to make the appearance of the objects attractive.

Due to the use of the physical vapor deposition formation process, the thin films or coatings finally obtained comprise thin electrically-conductive material layers. In use, charges may build up in the electrically-conductive material layer.

This usually does not cause problems. However, some objects subjected to the physical vapor deposition process may also need to use electrically sensitive sensors, for example, for driver's hand off detection (HOD), and charges building up on a PVD layer would interfere with detection results of a HOD assembly, for example, causing hysteresis or lower accuracy.

That is to say, when both a physical vapor deposition layer and a further electrically sensitive sensor are used, interference is caused due to charge buildup of the physical vapor deposition layer.

It is possible to consider using a carbon fibre layer as a common alternative material for the PVD layer. The carbon fibre layer may be very easy to come into contact with metal components by means of screws or other connection means so as to achieve grounding. However, there is a remarkable difference between the two materials, namely the carbon fibre layer and the PVD layer. The PVD layer is much thinner than the carbon fibre layer, and the PVD layer cannot structurally withstand a stress of screw or bolt connection, so that a grounding solution of the carbon fibre cannot be directly applied to the PVD layer.

### SUMMARY OF THE INVENTION

An objective of the present invention is to solve the above-mentioned technical problems in the prior art, that is, to provide an improved technical solution in terms of stress tolerance, which is intended to eliminate the interference caused by charge buildup of a physical vapor deposition layer.

The above-mentioned objective is achieved by an injection-moulded component provided with a coating on a surface thereof according to the present invention. The coating comprises a primer layer applied on the surface of the injection-moulded component, and a metal particle layer is applied on the primer layer by means of physical vapor deposition. According to the present invention, the coating is provided with at least one structural reinforcement portion which is configured to enable the coating to be tolerant to rigid connection implemented by means of the structural reinforcement portion.

Compared with a common PVD layer, the structural reinforcement portion has a higher strength. Therefore, the structural reinforcement portion can meet the higher strength requirements and stress requirements of a grounding connector. The structural reinforcement portion provides an additional reinforcement structure in a grounding region of the grounding connector. Therefore, a layer system cannot be broken due to the connection to the grounding connector, for example, due to tightening of a bolt. Moreover, charges on the PVD layer can be conducted away by means of the grounding connector.

According to an implementation, the structural reinforcement portion comprises an electrically-conductive material layer such that the coating and a target component rigidly connected to the coating can achieve an equipotential effect. In this way, interference caused by charge buildup is eliminated.

According to an implementation, the electrically-conductive material layer is provided with a first electrically-conductive adhesive sublayer, a copper foil sublayer and a second electrically-conductive adhesive sublayer from bottom to top.

The electrically-conductive material layer may also be formed in various ways. According to an implementation, the electrically-conductive material layer is provided with a first electrically-conductive adhesive sublayer, a first silver paste printing sublayer, a carrier sublayer, a second silver paste printing sublayer and a second electrically-conductive adhesive sublayer from bottom to top.

According to an implementation, the coating further comprises a topcoat layer, and the structural reinforcement portion is located between the metal particle layer and the topcoat layer.

According to an implementation, a topcoat layer is applied to the layer system. Different from the prior art, the topcoat layer has a blank portion at the structural reinforcement portion, rather than covering the entire surface.

According to an implementation, the topcoat layer is flush with the structural reinforcement portion after application.

According to an implementation, the structural reinforcement portion comprises a connection hole penetrating the surface of the injection-moulded component.

According to an implementation, the structural reinforcement portion covers only a partial area of the coating. Preferably, the structural reinforcement portion covers a structural surface region of the injection-moulded component that is adapted to connection.

Compared to the prior art, the stress tolerance is improved due to the fact that the coating is provided with at least one structural reinforcement portion that is configured to enable the coating to be tolerant to rigid connection implemented by means of the structural reinforcement portion.

The objective of the present invention is further achieved by a connection system. The connection system comprises an injection-moulded component according to the present invention, a target component corresponding to the injection-moulded component, and a connector for connecting the injection-moulded component to the target component.

The connection system according to the present invention comprises an injection-moulded component having a coating provided with at least one structural reinforcement portion. The structural reinforcement portion supports the ability to withstand a stress imposed on the connector, such as a strength generated during tightening of a screw or a bolt.

In an implementation of the connection system according to the present invention, the coating of the injection-moulded component comprises an electrically-conductive material layer, the connector is made of an electrically-conductive material, and at least part of the target component is made of an electrically-conductive material, wherein the coating of the injection-moulded component has the same electric potential as the target component after the injection-moulded component is connected to the target component by means of the connector, thereby eliminating the interference caused by charge buildup.

In an implementation of the connection system according to the present invention, when the target component is a grounded component, the coating of the injection-moulded component is also grounded.

According to an implementation of the present invention, the injection-moulded component comprises a threaded hole, and the connector is a screw or a bolt. The connection system may further comprise a perforated spacer or washer corresponding to the connection hole of the structural reinforcement portion. In this way, it is ensured that the connection region has a sufficient strength to meet the requirements for threaded connection such that the PVD layer cannot be broken.

According to a preferred implementation of the present invention, the target component is embodied as a steering wheel skeleton, and the injection-moulded component is embodied as a steering wheel accessory connected to the target component via of the connector.

The objective of the present invention is further achieved by a steering wheel cover plate. The steering wheel cover plate is formed by using an injection-moulded component as described above.

The present invention further relates to a steering wheel comprising such a steering wheel cover plate. A connection system as described above is applied to the steering wheel cover plate and the steering wheel skeleton of the steering wheel.

According to an implementation, the steering wheel cover plate is provided with one or more skeleton connection portions for connection to the steering wheel skeleton, and the structural reinforcement portion is provided at the one or more skeleton connection portions.

The objective of the present invention is further achieved by a steering wheel. The steering wheel is provided with a steering wheel cover plate according to the present invention.

In an implementation, the steering wheel cover plate is provided with one or more skeleton connection portions for connection to the steering wheel skeleton, and the structural reinforcement portion is provided at the one or more skeleton connection portions.

According to an implementation, a driver's a hand off detection sensor is provided on the steering wheel. The driver's hand off detection sensor is configured to detect whether user's hands are put on the steering wheel so as to ensure driving safety. The driver's hand off detection sensor generally detects whether the hands are put on the steering wheel according to the level of the electric potential. For example, when the driver's hands are in contact with the steering wheel, it is equivalent that the steering wheel is grounded, whereas when the driver's hands are not in contact with the steering wheel, the electric potential of the steering wheel is higher, and it is judged as hand off. During arrangement, a material of the driver's hand off detection sensor is generally wrapped around the steering wheel skeleton, and the PVD layer system is also generally mounted on the steering wheel skeleton, resulting in a relatively short distance or even contact between the two. In this case, if there is charge buildup on the PVD system layer adjacent to the driver's hand off detection sensor, it is likely to cause the electric potential detected by the driver's hand off detection sensor to change, thereby leading to interference with detection results of the sensor.

Since the structural reinforcement portion according to the present invention ensures the structural strength while eliminating the above-mentioned interference, breakage of the layer system is avoided.

The objective of the present invention is further achieved by a vehicle provided with a steering wheel according to the present invention.

### BRIEF DESCRIPTION OF THE DRAWINGS

The present invention will be further explained with reference to the accompanying drawings. In the figures:

FIG. 1 shows a schematic diagram of a PVD layer system according to the prior art;

FIG. 2 shows a schematic diagram of a layer system having an electrically-conductive material layer added thereto;

FIG. 3a shows a comparison diagram of a layer system according to an embodiment of the present invention and the layer system according to the prior art;

FIG. 3b shows a perspective comparison diagram of the layer system according to an embodiment of the present invention and the layer system according to the prior art;

FIG. 3c exemplarily shows a layer system according to an embodiment of the present invention, with the connection between a substrate with a coating and a main body according to the present invention being established by means of a connector;

FIG. 4 shows a schematic diagram of a steering wheel according to an embodiment of the present invention, which is provided with a steering wheel skeleton and a steering wheel cover plate; and

FIG. 5 shows a steering wheel cover plate provided with a physical vapor deposition layer according to an embodiment of the present invention.

### DETAILED DESCRIPTION OF EMBODIMENTS

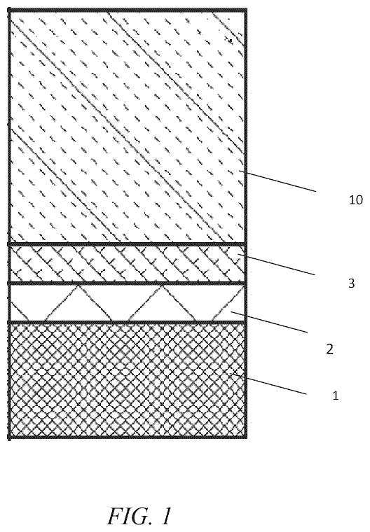

FIG. 1 shows a schematic diagram of a PVD coating according to the prior art. A primer layer 2 of the coating, a metal particle layer 3 formed by means of physical vapor deposition, and a topcoat layer 10 are applied to a substrate 1 of an injection-moulded component that is, for example, made of PC/ABS. As mentioned at the outset, charges build up on the metal particle layer.

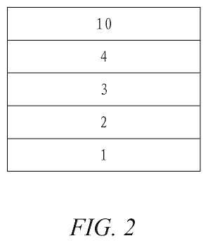

FIG. 2 shows a schematic view of a coating having an electrically-conductive material layer 4 added thereto. In this case, the charges build up in the electrically-conductive material layer 4.

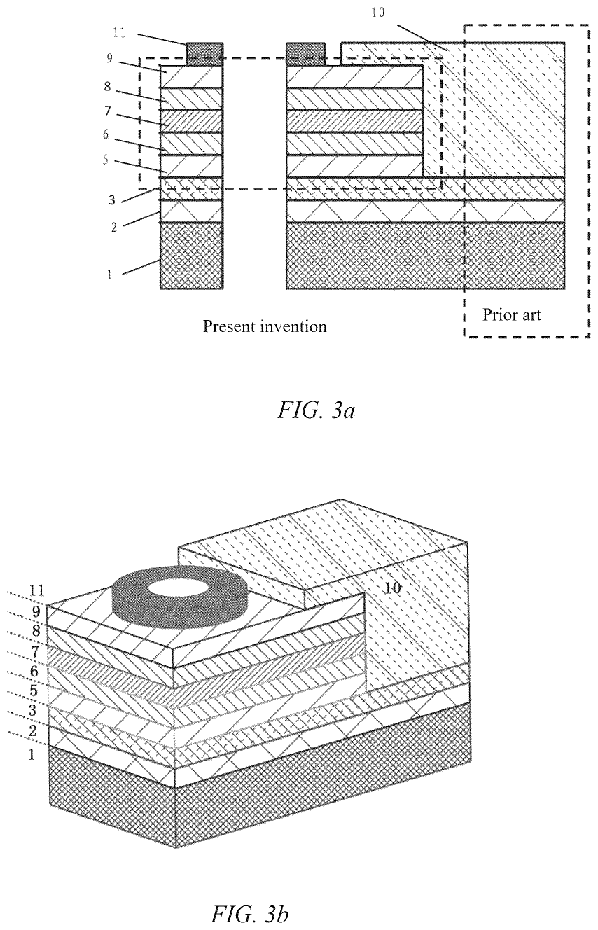

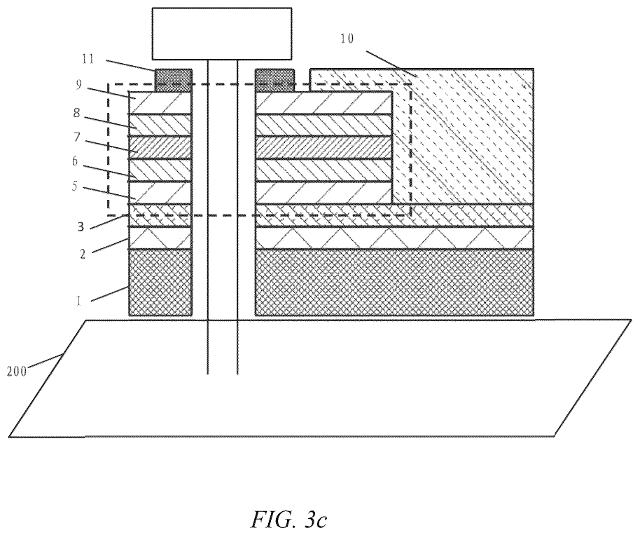

FIG. 3a shows a comparison diagram of a coating according to an embodiment of the present invention and the coating according to the prior art. In the coating according to the present invention on the left, the coating is provided with the primer layer 2, the metal particle layer 3 formed by means of physical vapor deposition, and the electrically-conductive material layer, which are applied to the substrate 1. The electrically-conductive material layer is composed of a first electrically-conductive adhesive sublayer 5, a first silver paste printing sublayer 6, a carrier sublayer 7, a second silver paste printing sublayer 8 and a second electrically-conductive adhesive sublayer 9. The electrically-conductive material layer is provided with a spacer 11 corresponding to a structural reinforcement portion.

It can be seen from FIG. 3a that, in contrast to the coating according to the prior art on the right, the topcoat layer according to the present invention has a blank portion at the structural reinforcement portion, rather than covering the entire surface. The spacer is provided at the blank portion.

FIG. 3b shows a perspective comparison diagram of a coating according to an embodiment of the present invention and the coating according to the prior art. It can be seen from the figure that the spacer is provided with a hole. A screw or a bolt of a grounding connector is tightened into the spacer. The spacer provides a reinforcement structure to prevent breakage of the coating.

FIG. 3c exemplarily shows a layer system according to an embodiment of the present invention, with the connection between a substrate with a coating and a main body according to the present invention being established by means of a connector. The connector is exemplarily a screw, and the substrate 1 is exemplarily a steering wheel cover plate. By using the screw, equipotential connection is established between the coated electrically-conductive layer of the substrate and a schematically shown frame 200. Thus, when the frame is grounded, that is, the electric potential of the frame is 0, the electric potential of the coating is also 0.

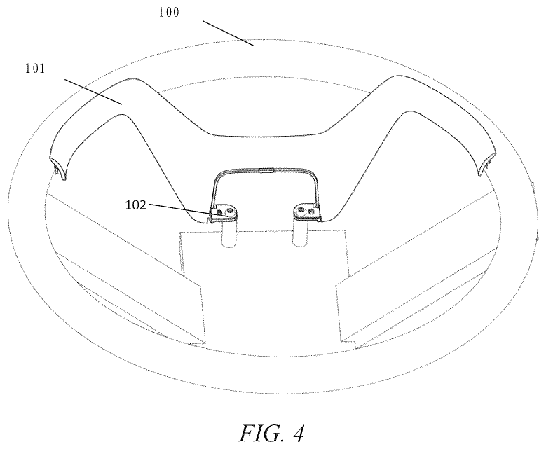

FIG. 4 shows a schematic diagram of a steering wheel according to an embodiment of the present invention, which is provided with a steering wheel skeleton 100 and a steering wheel cover plate 101. The steering wheel cover plate is provided with a coating according to the present invention. The steering wheel cover plate is provided with two skeleton connection portions 102 for connection to the steering wheel skeleton, and the structural reinforcement portion is provided at the skeleton connection portions.

A driver's hand off detection sensor (not shown) may be provided on the steering wheel. The skeleton connection portions for structural reinforcement of the grounding connector according to the present invention prevents breakage of the coating while eliminating interference with the driver's hand off detection sensor.

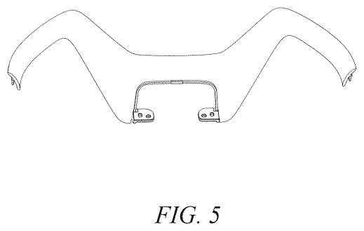

FIG. 5 shows a steering wheel cover plate provided with a physical vapor deposition coating according to an embodiment of the present invention. The steering wheel cover plate is likewise provided with two skeleton connection portions.

1. An injection-moulded component provided with a coating on a surface thereof, the coating comprising a primer layer applied on the surface of the injection-moulded component, and a metal particle layer being applied on the primer layer by means of physical vapor deposition,
wherein
the coating is provided with at least one structural reinforcement portion which is configured to enable the coating to be tolerant to rigid connection implemented by means of the structural reinforcement portion.

2. The injection-moulded component according to claim 1, wherein the structural reinforcement portion comprises an electrically-conductive material layer such that the coating and a target component rigidly connected to the coating are capable of achieving an equipotential effect.

3. The injection-moulded component according to claim 2, wherein the electrically-conductive material layer is provided with a first electrically-conductive adhesive sublayer, a copper foil sublayer and a second electrically-conductive adhesive sublayer from bottom to top.

4. The injection-moulded component according to claim 2, wherein the electrically-conductive material layer is provided with a first electrically-conductive adhesive sublayer, a first silver paste printing sublayer, a carrier sublayer, a second silver paste printing sublayer and a second electrically-conductive adhesive sublayer from bottom to top.

5. The injection-moulded component according to claim 2, wherein the coating further comprises a topcoat layer, and the structural reinforcement portion is located between the metal particle layer and the topcoat layer.

6. The injection-moulded component according to claim 5, wherein the topcoat layer is flush with the structural reinforcement portion after application.

7. The injection-moulded component according to claim 1, wherein the structural reinforcement portion comprises a connection hole penetrating the surface of the injection-moulded component.

8. The injection-moulded component according to claim 1, wherein the structural reinforcement portion covers only a partial area of the coating.

9. A connection system, wherein the connection system comprises the injection-moulded component according to claim 1, a target component corresponding to the injection-moulded component, and a connector for connecting the injection-moulded component to the target component.

10. The connection system according to claim 9, wherein the coating of the injection-moulded component comprises an electrically-conductive material layer, the connector is made of an electrically-conductive material, and at least part of the target component is made of an electrically-conductive material, wherein the coating of the injection-moulded component has the same electric potential as the target component after the injection-moulded component is connected to the target component via the connector.

11. The connection system according to claim 10, wherein when the target component is a grounded component, the coating of the injection-moulded component is also grounded.

12. The connection system according to claim 9, wherein the injection-moulded component comprises a threaded hole, and the connector is a screw or a bolt.

13. The connection system according to claim 12, wherein the connection system further comprises a perforated spacer or washer corresponding to the connection hole of the structural reinforcement portion.

14. The connection system according to claim 9, wherein the target component is a steering wheel skeleton, and the injection-moulded component is a steering wheel accessory connected to the target component via the connector.

15. A steering wheel cover plate, wherein it is implemented by using an injection-moulded component according to claim 1.

16. A steering wheel, comprising a steering wheel cover plate according to claim 15.

17. The steering wheel according to claim 16, wherein the steering wheel cover plate is provided with one or more skeleton connection portions for connection to the steering wheel skeleton, and the structural reinforcement portion is provided at the one or more skeleton connection portions.

18. The steering wheel according to claim 16, wherein on the steering wheel, a driver's a hand off detection sensor is provided adjacent to the steering wheel cover plate.

19. A vehicle, comprising a steering wheel according to claim 16.

20. The steering wheel according to claim 16, further comprising a connection system according to claim 9 applied to the steering wheel cover plate and a steering wheel skeleton of the steering wheel.
